(19) United States
(12) Patent Application Publication
(10) Pub. No.: US 2015/0098485 A1
(43) Pub. Date: Apr. 9, 2015

(54) DEVICE FOR GENERATING A HIGH TEMPERATURE GRADIENT IN A SAMPLE COMPRISING OPTICAL MONITORING MEANS

(71) Applicant: COMMISSARIAT A L'ENERGIE ATOMIQUE ET AUX ENERGIES ALTERNATIVES, Paris (FR)

(72) Inventors: Yves PONTILLON, PIERREVERT (FR); Eric HANUS, MANOSQUE (FR); Helene CAPDEVILA, PUYRICARD (FR)

(21) Appl. No.: 14/505,363

(22) Filed: Oct. 2, 2014

(30) Foreign Application Priority Data
Oct. 3, 2013 (FR) 1359586

(51) Int. Cl. G21C 17/00; G21C 17/112; G01N 1/44

(52) U.S. Cl. CPC G21C 17/001; G01N 1/44; G21C 17/112
USPC 374/55

(57) ABSTRACT

An assembly comprising a sample and a device for generating a high temperature gradient in said sample comprises: a chamber inside which the sample is placed; a resistor passing through the sample; first inductive means at the periphery of the chamber, for creating an electromagnetic field; and second inductive means that are arranged inside the chamber and connected to the resistor, and that are capable of picking up said electromagnetic field so as to make an induced current flow through said resistor, the chamber being transparent and the first inductive means comprising at least one first coil at least one coil of which contains windings separated by at least 2 mm, this separation being configured to allow an optical means for measuring deformation to be targeted.

### CROSS-REFERENCE TO RELATED APPLICATION

This application claims priority to foreign French patent application No. FR 1359586, filed on Oct. 3, 2013, the disclosure of which is incorporated by reference in its entirety.

### FIELD OF THE INVENTION

The field of the invention is that of heating devices used to controllably generate a thermal gradient in a sample, these devices notably being particularly advantageous for evaluating and characterizing the response of nuclear fuels to a thermal gradient, and that can be used in a high-activity nuclear laboratory.

In this field, it has already been proposed by the Applicant to produce a thermal gradient via electrical heating of fuel cores and by flowing water over the exterior of the cladding of these fuels. However, this device has not been used with irradiated nuclear fuels.

### BACKGROUND

Means allowing a thermal gradient to be produced are also known from patent U.S. Pat. No. 4,643,866, the gradient being created by heating the cores of fuel ceramics using microwaves and by flowing water over the exterior of the cladding of these ceramics.

In the publication Nuclear Engineering and Design 26, (1974) 423-431, J. F. Whatham moreover describes electrical heating of ceramics with cooling obtained by a flow of pressurized water.

Currently, the few reported thermal-gradient experiments, carried out on fuel rods, have been carried out on unirradiated materials in an inert atmosphere. However, the effects of irradiation rapidly (in less than one pressurized water reactor (PWR) cycle) have an impact on the mechanical and chemical properties of the pellet, of the cladding and of their interface, significantly modifying the behaviour of the nuclear fuel.

Now, in the context of management of fuels such as MOX fuels with a high content of plutonium with a degraded isotopic vector (mixed oxide (MOX) fuel contains plutonium dioxide PuO₂ and uranium dioxide UO₂ and is manufactured from approximately 7% plutonium and 93% uranium) our understanding of the effects of transfer of fission products, notably gaseous fission products, within the fuel and of release conditions needs to be improved.

More specifically, in the nuclear reactors currently operated by EDF, fuels take the form of UO₂ or (U,Pu)O₂ pellets stacked in a cladding made of a zirconium alloy. During irradiation, notably because of thermomechanical effects, an interaction occurs between the pellets and the cladding (also called the pellet-cladding interaction: PCI). Now, under certain accidental transient power conditions, the core of the fuel may experience a large and rapid increment in temperature relative to its normal situation, whereas the cladding surrounding this fuel does not necessarily experience such a temperature variation. This effect creates a large thermal gradient between the core of the fuel and the cladding of the fuel. This thermal transient therefore leads to an increase in the stress exerted by the pellet on the cladding, and may cause it to break. Since the cladding is the first containment barrier to fission products, it is essential to guarantee its integrity and therefore to understand as best as possible these PCI effects.

It would therefore be particularly advantageous to be able to carry out analytical experiments capable of simulating the thermal gradient experienced by a fuel or a nuclear fuel sample during various power “transients”, and more specifically to have available a device, able to be used in a high-activity laboratory, for characterizing the response of nuclear fuels to a thermal gradient. In other words, it is therefore also necessary to follow the deformations experienced by the fuel sample, due to this thermal gradient.

Such analytical experiments may make it possible to select materials with a view to obtaining a fuel that does not cause the first containment barrier to rupture under certain accidental transient power conditions.

### SUMMARY OF THE INVENTION

In this context, the Applicant has developed an experimental device

called DURANCE (Device simUlating the Response to thermAl gradieNts of nuClear fuEls). This DURANCE device creates a thermal gradient in the sample, by way of a heating mandrel inserted into the core and a system of insulating materials cooled by an ancillary device. The amplitude of the thermal gradient between the core of the sample and the outer face of the cladding is, therefore, set by the temperature in the core and the nature, thickness and external temperature of the insulators.

In this context, the Applicant has sought to develop a device that makes it possible to reproduce and control the amplitudes of the thermal gradients experienced by nuclear fuels during certain accidental situations, and to do so using a small piece of apparatus that can be easily adapted to the heat treatment ovens used in laboratory high-activity cells, the device not requiring a flow of water (pressurized or not) to make contact with the fuel element and the heating being ensured by induction. The Applicant has also sought to make this device compatible with on-line and in situ means for measuring the deformations experienced by the fuel sample, optical measuring means in particular. The developed inductive heating system, typically for heating a sample of two to three fuel pellets, ensuring a flow of heat from the interior to the exterior of the latter, makes it possible to reproduce the temperature profile observed in a reactor. This system is intended to allow progress to be made on problems related to the risk of the claddings of fuel rods rupturing via pellet-cladding interaction (PCI) and/or stress corrosion (SC) during an incident, the limited number of complete power ramp experiments having prevented the entire range of parameters and fuel grades from being tested individually and the physical effects at play from being decoupled. Thus, certain key mechanisms involved in the interaction of the pellet with the cladding are as yet poorly understood and constitute a factor limiting understanding of these ramps and the accuracy of digital models of PCIs. Currently, large margins are allowed for in order to prevent rupture of the cladding.

One of the main objectives of the device proposed in the present invention is therefore to reproduce and control the amplitude of the thermal gradient experienced by a nuclear fuel during certain accidental situations and to do so using a small piece of apparatus that can be easily adapted to the heat treatment ovens used in laboratory high-activity cells, the device not requiring a flow of water (pressurized or not) to make contact with the fuel element and the heating being ensured by induction. This objective is obtained by an assembly comprising a sample and a device for generating a high temperature gradient in said sample, comprising:
a chamber inside which said sample is placed;
a resistor passing through said sample;
first inductive means at the periphery of the chamber, for creating an electromagnetic field; and
second inductive means that are connected to the resistor and that are capable of picking up said electromagnetic field so as to make an induced current flow through said resistor.

However, another objective essential to the understanding of the effects described above is to make it possible to measure on-line and in situ the deformations experienced by the sample, and to quantify them. Now, the assembly described above and the area to be studied place many constraints on this measurement. Specifically, the aim is to detect and quantify deformations having an amplitude ranging from a few microns to about one-hundred microns, this amplitude being small compared to the minimum working distance (10 cm), and to do so under the constraints associated with working in a nuclear environment, and in a small space.

The analysis of the deformations experienced by the sample in the assembly described above may be carried out only a posteriori and external to this assembly, making it impossible to relate these deformations to experimental parameters.

The device of the present invention notably provides a solution allowing the central temperature of a fuel sample to be raised, possibly to 2000° C. or above, while stabilizing the temperature of the cladding of this fuel sample at about 350° C.+/−50° C., this solution necessarily allowing the deformations experienced by the sample under the extreme conditions indicated above to be measured on-line and in situ optically, and quantified.

More specifically, the subject of the present invention is an assembly comprising a sample and a device for generating a high temperature gradient in said sample, comprising:
a chamber inside which said sample is placed;
a resistor passing through said sample;
first inductive means at the periphery of the chamber, for creating an electromagnetic field; and
second inductive means that are arranged inside the chamber and connected to the resistor, and that are capable of picking up said electromagnetic field so as to make an induced current flow through said resistor,
   characterized in that the chamber is transparent at visible wavelengths and in that the first inductive means comprise at least one first coil comprising coil elements (or windings) at least certain of which are separated by a minimum gap d of 2 mm, this spacing being configured to allow an optical means for measuring deformation to be targeted.

According to one variant of the invention, the second inductive means comprise at least one second coil.

According to one variant of the invention, the chamber is a quartz tube.

According to one variant of the invention, the sample comprises a ceramic pellet that may be made of Al₂O₃ or of ZrO₂ or a nuclear fuel pellet that may be made of UO₂ or of MOX.

According to one variant of the invention, the sample comprises a metal cladding at the periphery of said pellet and making direct contact with said pellet.

According to one variant of the invention, it furthermore comprises a thermally insulating element that is transparent at visible wavelengths, at the periphery of said sample.

According to one variant of the invention, the transparent thermally insulating element is made of sapphire.

According to one variant of the invention, the transparent thermally insulating element is made of glass.

According to one variant of the invention, the transparent thermally insulating element is made of diamond.

According to one variant of the invention, the resistor is made of a refractory metal, possibly tungsten or molybdenum.

According to one variant of the invention, said assembly furthermore comprises an exchanger, said second inductive means being located at the periphery of said exchanger.

In one preferred embodiment, the exchanger comprises a slit or a transparent window, either one being configured to allow a means for measuring deformation to be targeted.

According to one variant of the invention, the exchanger comprises a system for making a fluid flow.

According to one variant of the invention, said assembly furthermore comprises means for measuring the temperature of said sample.

According to one variant of the invention, the temperature measuring means comprise a thermocouple.

According to one variant of the invention, the temperature measuring means comprise a pyrometer.

According to one variant of the invention, the temperature measuring means comprise an infrared video camera.

### BRIEF DESCRIPTION OF THE DRAWINGS

The invention will be better understood, and other advantages will become apparent, on reading the following description, given by way of nonlimiting example, and from the appended figures in which:

FIG. 1 illustrates a device according to the prior art;

FIG. 2 illustrates a device according to the invention;

FIGS. 3a and 3b illustrate geometric models of the assembly: fuel pellet surrounded by insulator, heated notably by a metal mandrel in a device of the invention;

FIG. 4 illustrates the finite element thermal model of a fuel pellet surrounded by insulator;

FIG. 5 illustrates an exploded view of various elements included in an example device of the invention; and

FIG. 6 illustrates an example temperature cycle applied to the central resistor in a device of the invention.

### DETAILED DESCRIPTION

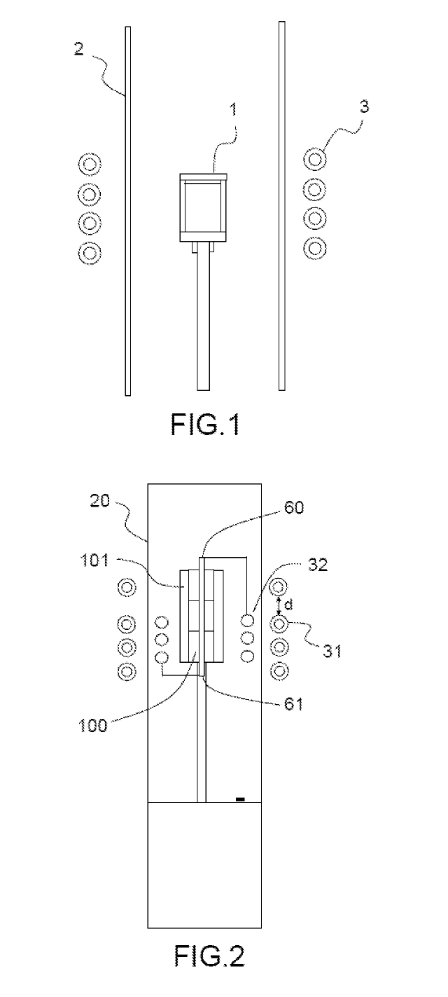

The Applicant has developed a heating oven such as that illustrated in FIG. 1, making it possible to heat a metal crucible by inductive coupling. A high-frequency current is made to flow through windings referred to as inductive windings 3, creating induced currents in the metal crucible 1. These induced currents thus heat the walls of the crucible via Joule heating, the crucible itself then heats a sample to a high temperature isothermally, the crucible itself being placed in a tube 2. The tube 2 is for example made of quartz.

However, such an inductive heating oven cannot be used unmodified in the DURANCE device. Specifically, it is not envisageable to use the resistor inserted in the centre of the sample to be heated as a susceptor (generally, the susceptor must be made of an electrical conductor) for the induction as the cladding, which is made of a zirconium alloy (and which is therefore a metal, and therefore very conductive, element), is located between the centre of the pellets and the winding and would thus undergo coupling. In the configuration of the heating oven illustrated in FIG. 1, the cladding would therefore be heated in the same way as the metal crucible.

In order to be able to make use of the electromagnetic field created by first inductive means, possibly an inductive winding, to heat the central resistive system, the solution proposed in the present invention adapts the principle of an electrical transformer.

The electromagnetic field is thus, according to the present invention, picked up by first inductive means, possibly a winding (coil) referred to as the transformation winding. This winding then creates a so-called induced current that flows through the resistor. This winding is placed inside the tube 2 and centred relative to the inductive winding.

This device indeed makes it possible to keep the same power supply system as the heating oven in FIG. 1. It also makes it possible to retain the tube 2, which is for example made of quartz, which guarantees the seal-tightness of the oven and which, because of its physico-chemical properties, does not interact with the coupling effect.

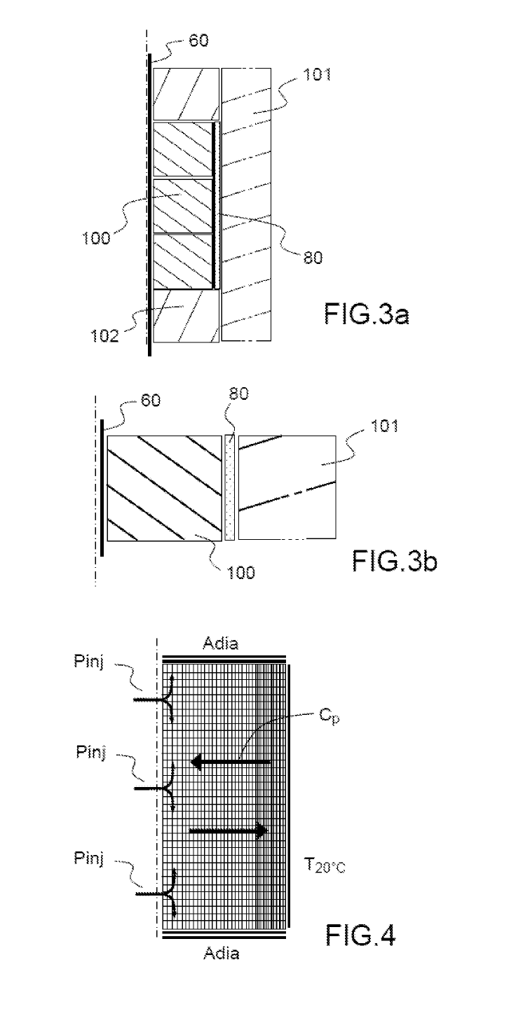

Thus, FIG. 2 illustrates a device of the invention comprising, in a chamber 20, a resistor 60, a first winding referred to as the inductive winding 31 and a second winding referred to as the transformation winding 32. The sample to be heated 100 is encircled by a cladding 80, shown in FIGS. 3a and 3b, and by an insulator 101, and the resistor 60 passes through its centre. A thermocouple 61 is also provided for the temperature measurement. The transformation winding 32 is mechanically connected to the resistor 60 so as to ensure heat is conducted from the winding 32 to the resistor 60.

The inductive winding 31 contains at least some winding elements that have a minimum gap d of 2 mm between them. In the example shown, only one portion of the coil elements has this minimum gap, but it is entirely possible to have the same minimum gap over all of the inductive winding 31.

The insulator 101 is made of a transparent material, for example of sapphire, glass or diamond.

This configuration makes it possible for an optical device to reach the cladding in order to carry out the measurement of deformations of the sample on-line and in situ, and thus allows the deformation to be related to experimental parameters, thus making a better understanding of the physical effects at play possible.

The device of the present invention thus makes it possible to heat, via inductive coupling, the metal element, namely the resistor 60, and then, via resistive heating of the resistor 60, to heat the interior of the pellets.

In order to obtain in this way more uniform heating within the stack of fuel pellets, the coupling windings may advantageously be doubled and two metallic elements heated on either side by induction.

Thermal Validation of the Resistive Heating System

Generally, the DURANCE device seeks to create a known and preset radial thermal gradient in an irradiated nuclear ceramic. In order to validate the envisaged concept, the Applicant has modelled, in Cast3m, the thermal behaviour of the device of the invention. This modelling made it possible, initially, and through a parametric study that is as simple as possible, to confirm the presence of a radial gradient in the pellets and to specify the nature and geometry of the insulators required to obtain the desired thermal gradient. This analysis details the assumptions made to obtain a simplified DURANCE model (definition of the geometrical model, definition of the thermal model, etc.). The results obtained were compared to the required objectives to conclude whether the concept was valid or not. It was decided to model the DURANCE device axisymmetrically, initially on a stack of three pellets and then, to further simplify the model, on only one central pellet by disregarding the edge effects of the two end pellets. There is considered to be no heat exchange via the bottom and top faces (adiabatic conditions). FIGS. 3a and 3b illustrate the various elements shown in cross section from the central resistor 60: more precisely the figure shows, from the centre of the sample to the exterior of the pellet, the fuel 100 placed between two chocks 102, the cladding 80 and the insulator 101. There is also considered to be no play between the pellets and the cladding and between the cladding and the insulator. Since contact is considered to be perfect between these elements, just one heat transfer mode is considered: conduction.

The cooling circuit is modelled by a temperature set to 20° C., corresponding to the temperature of the water flowing in the exchanger as illustrated in FIG. 4, which shows, according to the thermal model, the power per unit volume injected Pᵢₙⱼ and the almost perfect conduction Cₚ between the various materials (pellet, cladding, insulator) between two adiabatic surfaces A_{dia}.

Based on this thermal model, which made it possible to validate that a thermal gradient and an a priori adequate heating principle were obtained, the Applicant produced a prototype in order to verify the general principle and the correct operation of the assembly and notably to verify the resistive heating and that a thermal gradient was created by way of the various insulators and the use of a cooling system, and that it was possible to carry out an optical measurement of the deformations.

To make production of this prototype possible, various elements were required:
a resistor 60 allowing the desired temperatures to be reached without excessive deformation thereof;
pellets drilled in order to receive the resistor, as a sample;
a three-pierced-pellet-high zircaloy4 (zirconium) cladding 80, and end chocks;
a set of transparent insulators 101;
two windings, a transformation winding 32 for making induced currents flow through the resistor, and an inductive winding 31; and
a heat exchanger 40, equipped with a transparent targeting window 41, in order to set the exterior temperature of the insulator to the flow temperature of the water (i.e. 20° C.).

FIG. 5 shows these elements: the tungsten central resistor 60, the cladding 80, the three fuel pellets 100 inserted between two chocks 102, the insulator 101 and a water exchanger 40, these various elements then interfitting to form the complete system which allows, using the windings, the fuel pellets to be heated while the cladding is cooled via the cooling circuit.

The insulator 101 is made of a transparent material, for example of sapphire, glass or diamond.

The exchanger 40 comprises a transparent aperture 41, for example a slit in the exchanger having undergone machining tailored to the window.

The assembly thus formed is incorporated into the transformation winding 32.

The assembly thus formed may be incorporated into a quartz tube 2, thereby forming an advancement of the heating oven in FIG. 1 and of the assembly comprising a sample and a device for generating a high temperature gradient in said sample, comprising:
a chamber inside which said sample is placed;
a resistance passing through said sample;
first inductive means at the periphery of the chamber, for creating an electromagnetic field; and
second inductive means that are connected to the resistor and that are capable of picking up said electromagnetic field so as to make an induced current flow through said resistor.

The inductive winding 31 then couples to the transformation winding 32, the latter being short-circuited by the tungsten resistor 40 passing through the sample 100. The transformation winding 32, the inductive winding 31 and the exchanger 40 are all water-cooled.

A thermocouple 61, shown in FIG. 2, is mounted in contact with the resistor in order to observe its behaviour when the device is powered up.

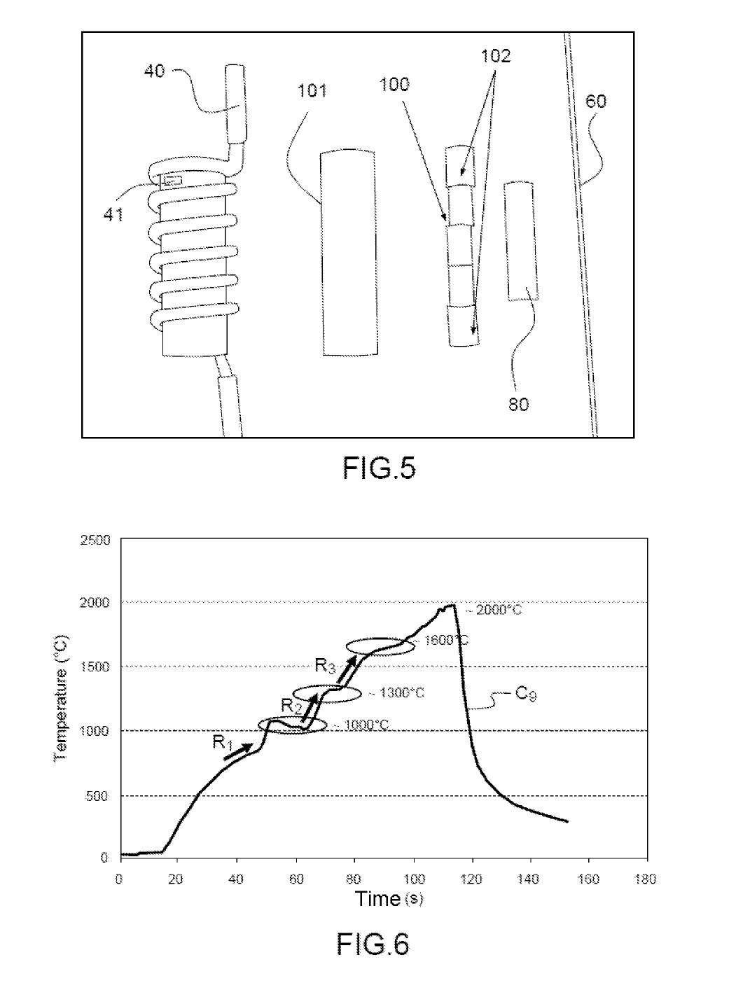

FIG. 6 illustrates temperature cycles as applied to the resistor. Three different ramps were applied and four temperature plateaus (1000° C., 1300° C., 1600° C. and 2000° C.) were maintained between the ramps R₁, R₂ and R₃, the curve C₉ relating to the temperature of the susceptor. The temperature of the resistor is deliberately limited to a temperature of 2000° C. over a very short time period.

These measurements validate the heating principle proposed in the present invention, allowing for more or less rapid temperature ramps, with temperature levels in the required ranges.

It will be understood that the assembly according to the invention allows temperature gradients to be produced between the interior and exterior of a sample suitable for on-line and in situ measurement of the deformations experienced by the sample, and for this to be done under the extreme conditions of the working environment.

One possible application of such an assembly is the qualification of nuclear fuels.

Other applications are the qualification of other materials under extreme conditions, or when it is important to be able to heat a material and measure its deformations on-line and in situ in a small space.

1. An assembly comprising a sample and a device for generating a high temperature gradient in said sample, comprising:
a chamber inside which said sample is placed;
a resistor passing through said sample;
first inductive means at the periphery of the chamber, for creating an electromagnetic field; and
second inductive means that are arranged inside the chamber and connected to the resistor, and that are capable of picking up said electromagnetic field so as to make an induced current flow through said resistor,
wherein the chamber is transparent at visible wavelengths and the first inductive means comprise at least one first coil comprising coil elements or windings at least certain of which are spaced apart by a distance of 2 mm, the spacing being configured to allow an optical means for measuring deformation to be targeted.

2. The assembly according to claim 1, in which the chamber is a quartz tube.

3. The assembly according to claim 1, further comprising a transparent thermally insulating element at the periphery of said sample.

4. The assembly according to claim 3, in which the transparent thermally insulating element is made of sapphire.

5. The assembly according to claim 3, in which the transparent thermal insulator is made of glass.

6. The assembly according to claim 3, in which the transparent thermal insulator is made of diamond.

7. The assembly according to claim 1, further comprising an exchanger, said second inductive means being located at the periphery of said exchanger, the exchanger comprising a slit or a transparent window, either one being configured to allow a means for measuring deformation to be targeted.
